(19) United States
(12) Patent Application Publication
(10) Pub. No.: US 2013/0154798 A1
(43) Pub. Date: Jun. 20, 2013

(54) ELECTRONIC DEVICE AND DISPLAY METHOD

(71) Applicant: Chia-Hsiang Chen, Taipei City (TW)

(72) Inventor: Chia-Hsiang Chen, Taipei City (TW)

(73) Assignee: INVENTEC CORPORATION, Taipei City (TW)

(21) Appl. No.: 13/433,757

(22) Filed: Mar. 29, 2012

(30) Foreign Application Priority Data
Dec. 19, 2011 (TW) 100147159

(51) Int. Cl. G08B 5/22

(52) U.S. Cl. 340/6.1

(57) ABSTRACT

An electronic device and a display method are provided. The electronic device includes a light emitting unit, an input switch, a power control unit, a register data storage unit and a signal control module. The input switch is configured to produce a switch signal and an address signal. The power control unit is configured to transmit power status data. The register data storage unit is configured to provide corresponding register data according to the address signal. The signal control module is electrically coupled to the light emitting unit, the power control unit, the register data storage unit and the input switch, and is configured to selectively receive the register data from the register data storage unit or the power status data from the power control unit according to the switch signal, and transmit the selected data to the light emitting unit.

### CROSS-REFERENCE TO RELATED APPLICATION

This application claims the priority benefit of Taiwan application serial no. 100147159, filed on Dec. 19, 2011. The entirety of the above-mentioned patent application is hereby incorporated by reference herein and made a part of this specification.

### BACKGROUND OF THE INVENTION

1. Field of the Invention

The present invention generally relates to a hardware monitoring mechanism, in particular, to an electronic device using a light emitting unit to display status stored in hardware and a display method thereof.

2. Description of Related Art

In many products, the power supply sequence of elements is very important, and accordingly power supply sequencing becomes a key function. Currently, in most cases, a complex programmable logic device (CPLD) is used for realizing power sequence control.

In a CPLD architecture, if the user wants to obtain memory map data stored in a hardware register and relating to a baseboard management controller (BMC) and a low pin count (LPC), software support and an external screen are required. For example, the memory map data of the BMC is read through an instruction of BMC monitoring software, while the memory map data of the LPC is read through software resources of a basic input output system (BIOS) and a disk operating system (DOS), and the read result is displayed on the external screen.

Therefore, the user cannot effectively obtain the memory map data of the BMC and the LPC without software support or an external screen during circuit inspection and troubleshooting.

### SUMMARY OF THE INVENTION

The present invention is directed to an electronic device, which can effectively obtain data of hardware internal status without software support or screen display.

The present invention is also directed to a display method, which can display data of internal status through a light signal of a light emitting unit, so as to use the data as a basis for circuit inspection and troubleshooting.

The present invention provides an electronic device, which includes a light emitting unit, an input switch, a power control unit, a register data storage unit and a signal control module. The light emitting unit is configured to display register data of the register data storage unit or power status data of the power control unit. The input switch is configured to produce a switch signal and an address signal. The power control unit is configured to transmit the power status data. The register data storage unit is configured to provide corresponding register data according to the address signal. The signal control module is electrically coupled to the light emitting unit, the power control unit, the register data storage unit and the input switch, and is configured to selectively receive the register data from the register data storage unit or the power status data from the power control unit according to the switch signal produced by the input switch, and transmit the selected data to the light emitting unit.

In an embodiment of the present invention, the signal control module further includes a selecting unit, electrically coupled to the input switch, and configured to receive the switch signal, and selectively transmit the power status data or the register data to the light emitting unit.

In an embodiment of the present invention, the signal control module further includes a data register and a power status register. The data register is electrically coupled to the register data storage unit and the selecting unit, and is configured to temporarily store the register data from the register data storage unit. The power status register is electrically coupled to the power control unit and the selecting unit, and is configured to temporarily store the power status data from the power control unit. The selecting unit switches to be electrically coupled to the data register, or switches to be electrically coupled to the power status register according to the switch signal.

In an embodiment of the present invention, the signal control module further includes a display data register, electrically coupled to the light emitting unit and the selecting unit, and configured to temporarily store an output of the selecting unit.

In an embodiment of the present invention, the input switch includes a first input unit and a second input unit. The first input unit is configured to produce the switch signal. The second input unit is configured to produce the address signal.

The present invention provides a display method. The method uses a light emitting unit to display internal status of an electronic device, and the electronic device includes the light emitting unit, a power control unit, a register data storage unit and an input switch. Herein, a switch signal is produced via the input switch, and the register data storage unit or the power control unit is selected according to the switch signal. Power status data of the power control unit is transmitted to the light emitting unit, when the power control unit is selected. Register data of the register data storage unit is transmitted to the light emitting unit, when the register data storage unit is selected.

In an embodiment of the present invention, the display method further includes producing an address signal via the input switch; transmitting the address signal to the register data storage unit, so that the register data storage unit provides the corresponding register data to a data register; and transmitting the register data in the data register to the light emitting unit, when the register data storage unit is selected by the input switch.

The present invention provides an electronic device, which includes an input switch, a power control unit, a register data storage unit and a signal control module. The input switch is configured to produce a switch signal and an address signal. The power control unit is configured to transmit power status data. The register data storage unit is configured to provide corresponding register data according to the address signal. The signal control module is electrically coupled to the power control unit, the register data storage unit and the input switch, and configured to selectively receive the register data from the register data storage unit or the power status data from the power control unit according to the switch signal, and output the selected data.

In an embodiment of the present invention, the electronic device further comprises a light emitting unit. The light emitting unit is electrically coupled to the signal control module for receiving the selected data from the signal control module.

In an embodiment of the present invention, the signal control module comprises a selecting unit. The selecting unit is electrically coupled to the input switch, and configured to receive the switch signal, and selectively transmit the power status data or the register data to the light emitting unit.

In an embodiment of the present invention, the signal control module further comprises a data register and a power status register. The data register is electrically coupled to the register data storage unit and the selecting unit, and configured to temporarily store the register data. The power status register is electrically coupled to the power control unit and the selecting unit, and configured to temporarily store the power status data.

In an embodiment of the present invention, the selecting unit switches to be electrically coupled to the data register, or switches to be electrically coupled to the power status register according to the switch signal.

In an embodiment of the present invention, the signal control module further comprises a display data register. The display data register is electrically coupled to the light emitting unit and the selecting unit, and configured to temporarily store an output of the selecting unit.

In an embodiment of the present invention, the input switch comprises a first input unit and a second input unit. The first input unit configured to produce the switch signal. The second input unit configured to produce the address signal.

Based on the above, in the present invention, the internal status of the electronic device and to be displayed by the light emitting unit is selected via the input switch, so that the user can know whether the internal status of the electronic device is abnormal through table look-up according to the prompt of the light emitting unit, even without software support or screen display.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device according to an embodiment of the present invention.

FIG. 2 is a flowchart of a display method according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

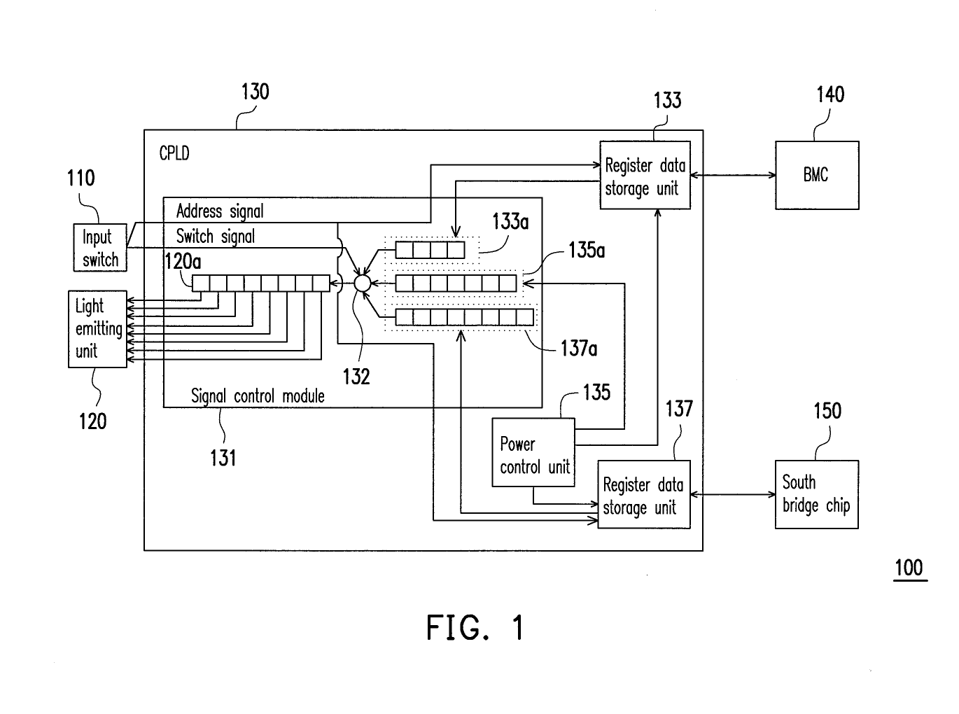

FIG. 1 is a block diagram of an electronic device according to an embodiment of the present invention. In this embodiment, the electronic device 100 includes an input switch 110, a light emitting unit 120, a CPLD 130, a BMC 140 and a south bridge chip 150. For the convenience of illustration, the south bridge chip 150 is taken as an example in this embodiment, while in other embodiments, the south bridge chip 150 may be replaced by a chip set integrating a south bridge chip and a north bridge chip, but the present invention is not limited thereto.

The CPLD 130 is configured to perform data conversion, access and control, and includes a signal control module 131, a register data storage unit 133, a power control unit 135, and a register data storage unit 137. Herein, the signal control module 131 is electrically coupled to the light emitting unit 120, the power control unit 135, the register data storage unit 133, the register data storage unit 137, and the input switch 110. In addition, in this embodiment, the signal control module 131 further includes a selecting unit 132, a display data register 120a, a data register 133a, a power status register 135a, and a data register 137a. Herein, the selecting unit 132, for example, is a multiplexer, which is electrically coupled to the input switch 110, the data register 133a, the power status register 135a, the data register 137a and the display data register 120a. Furthermore, the data register 133a and the data register 137a are electrically coupled to the register data storage unit 133 and the register data storage unit 137 respectively. The power status register 135a is electrically coupled to the power control unit 135. The display data register 120a is electrically coupled to the light emitting unit 120.

The input switch 110 is configured to produce a switch signal and an address signal, and transmit the switch signal and the address signal to the signal control module 131. Herein, the input switch 110, for example, is a DIP (dual in-line package) switch of 8 bits, a part of which may be set as a first input unit to produce the switch signal, and the rest of which may be set as a second input unit to produce the address signal. For example, the first input unit includes 2 bits, and the second input unit includes 6 bits. This is just an example for illustration, and the present invention is not limited thereto.

The power control unit 135 is configured to transmit power status data to the power status register 135a of the signal control module 131. Herein, the power status register 135a, for example, is a register of 7 bits, for temporarily storing the power status data therein.

The register data storage unit 133, for example, is electrically coupled to the BMC 140 via an X-Bus, stores a memory map table of the BMC 140, and provides corresponding register data to the data register 133a according to the address signal. Herein, the data register 133a is set as a register of 4 bits, but the present invention is not limited thereto, and each system may compile and practice bit numbers of internal registers according to requirements. The BMC 140 is configured to perform hardware detecting functions (such as processor temperature, fan speed and voltage value) and is capable of issuing an instruction operation to monitor hardware status, enabling a remote user to perform system management and troubleshooting.

The register data storage unit 137, for example, is electrically coupled to the south bridge chip 150 via an LPC bus, stores a memory map table of the LPC, and provides corresponding register data to the data register 137a according to the address signal. Herein, the data register 137a is set as a register of 8 bits, but the present invention is not limited thereto, and each system may compile and practice bit numbers of internal registers according to requirements. The register data in the register data storage unit 137, for example, is obtained by reading from software resources of a BIOS and a DOS via the south bridge chip 150.

The signal control module 131 selectively receives the register data of the register data storage unit 133 or 137 or the power status data of the power control unit 135 according to the switch signal, and transmits the selected data to the light emitting unit 120. Further, the selecting unit 132 switches to be electrically coupled to the data register 133a or the data register 137a, or switches to be electrically coupled to the power status register 135a according to the switch signal, so as to select data stored in one of the data register 133a, the power status register 135a and the data register 137a, and input the selected data to the display data register 120a. Since the largest one among the data register 133a, the power status register 135a and the data register 137a is of 8 bits, the display data register 120a is set as a register of 8 bits.

For example, the input switch 110 is a DIP switch of 8 bits, and it is assumed that the first 2 bits are set as the first input unit, and the last 6 bits are set as the second input unit. Furthermore, it is assumed that switch signals “00”, “01” and “10” correspond to the power status register 135a, the data register 133a and the data register 137a respectively. The register data of the data register 133a is transmitted to the display data register 120a, when the switch signal received by the selecting unit 132 is “01”. By such analogy, the power status data is stored in the display data register 120a, when the switch signal is “00”; the register data of the data register 137a is stored in the display data register 120a, when the switch signal is “10”. In addition, the address signal produced by the second input unit is transmitted to the register data storage unit 133 and the register data storage unit 137 respectively, so that the two register data storage units 133 and 137 read register data corresponding to the address signal, and transmit the register data to the corresponding data registers 133a and 137a. Assuming that the address signal is “000101”, the register data storage unit 133 and the register data storage unit 137 provide register data having an address of “0x05” to the data register 133a and the data register 137a respectively.

Herein, the light emitting unit 120, for example, is a light emitting diode (LED) display of 8 bits, and each bit corresponds to each bit of the display data stored in the display data register 120a respectively, where the output of the selecting unit 132 is temporarily stored in the display data register 120a.

In this embodiment, although the two register data storage units and the corresponding data registers are provided, an electronic device including one or more than two register data storage units and corresponding data registers may be implemented. The number of the data registers and the control type of the input switch are not limited in the present invention, and if only one register data storage unit is provided, the switch signal of the input switch may be represented by only 1 bit.

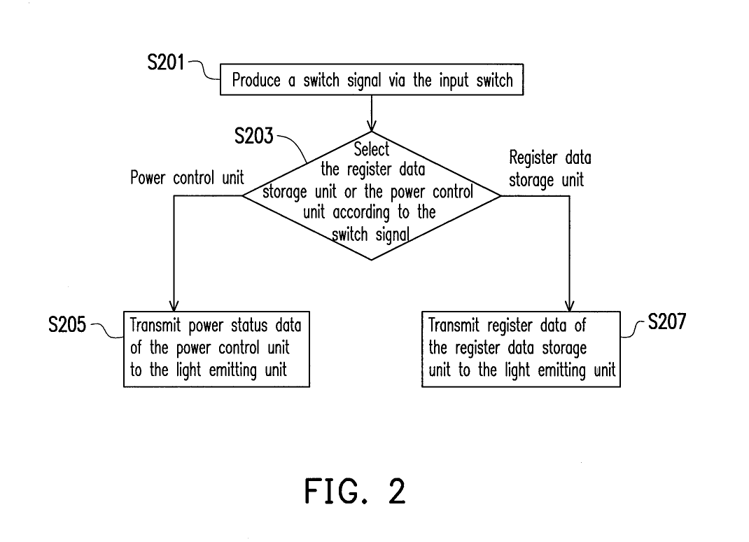

Another embodiment is provided for illustration as follows. FIG. 2 is a flowchart of a display method according to an embodiment of the present invention. Referring to FIG. 1 and FIG. 2, in Step S201, a switch signal is produced via the input switch 110. The user may operate the input switch 110 (such as a DIP switch) to produce a switch signal and an address signal corresponding to the operation after the electronic device 100 starts to work. The switch signal is transmitted to the selecting unit 132. In addition, if the user also produces an address signal via the input switch 110, the address signal is transmitted to the register data storage unit 133 and the register data storage unit 137, so that the register data storage unit 133 and the register data storage unit 137 provide corresponding register data to the data register 133a and the data register 137a respectively.

Next, in Step S203, the selecting unit 132 selects the register data storage unit 133, the register data storage unit 137 or the power control unit 135 according to the switch signal received from the input switch 110, so as to determine to transmit the register data of the data register 133a or the data register 137a, or the power status data of the power status register 135a to the display data register 120a. If the power control unit 135 is selected, Step S205 is performed. If the register data storage unit 133 or 137 is selected, Step S207 is performed.

In Step S205, the power status data of the power control unit 135 is transmitted to the light emitting unit. In detail, the selecting unit 132 switches to be electrically coupled to the power status register 135a according to the switch signal, so as to set the power status data in the power status register 135a as the display data of the display data register 120a, so that the light emitting unit 120 operates according to the display data, for example, lights a corresponding light signal.

In Step S207, the register data of the register data storage unit 133 or 137 is transmitted to the light emitting unit 120. Further, the selecting unit 132 switches to be electrically coupled to the data register 133a or the data register 137a according to the switch signal, so as to set the register data of the data register 133a or the data register 137a as the display data of the display data register 120a, so that the light emitting unit 120 operates according to the display data. The user also produces an address signal via the input switch 110 to determine the register data to be displayed, when the switch signal is produced via the input switch 110 for switching to the register data storage unit 133 or the register data storage unit 137.

If the input switch 110 produces an address signal, the register data storage unit 133 and the register data storage unit 137 respectively read register data corresponding to an address in the address signal according to the received address signal, and transmit the data to the data register 133a and the data register 137a. Also, the selecting unit 132 determines to be electrically coupled to the data register 133a or the data register 137a according to the switch signal.

For example, the input switch 110 is a DIP switch of 8 bits, and it is assumed that the first 2 bits are set as the first input unit for producing the switch signal, and the last 6 bits are set as the second input unit for producing the address signal. Furthermore, it is assumed that switch signals “00”, “01” and “10” are configured to switch to the power control unit 135, the register data storage unit 133 and the register data storage unit 137 respectively. Assuming that the user inputs “01000101” via the DIP switch, the light emitting unit 120 displays register data having an address of “0x05” in the register data storage unit 133.

In addition, the output of the light emitting unit 120 may be preset as the power status data. That is to say, the light emitting unit 120 displays the status of the power control unit 135 before switching.

Based on the above, in the abovementioned embodiments, by switching via the input switch, the light emitting unit can not only display the power status data for power monitoring, but also display the register data of the LPC and the BMC without an external screen, so that circuit inspection and troubleshooting can be effectively implemented according to the light signal display of the light emitting unit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a light emitting unit;
an input switch configured to produce a switch signal and an address signal;
a power control unit configured to transmit power status data;
a register data storage unit configured to provide corresponding register data according to the address signal; and
a signal control module electrically coupled to the light emitting unit, the power control unit, the register data storage unit and the input switch, and configured to selectively receive the register data from the register data storage unit or the power status data from the power control unit according to the switch signal, and transmit the selected data to the light emitting unit.

2. The electronic device according to claim 1, wherein the signal control module comprises:
a selecting unit, electrically coupled to the input switch, and configured to receive the switch signal, and selectively transmit the power status data or the register data to the light emitting unit.

3. The electronic device according to claim 2, wherein the signal control module further comprises:
a data register, electrically coupled to the register data storage unit and the selecting unit, and configured to temporarily store the register data; and
a power status register, electrically coupled to the power control unit and the selecting unit, and configured to temporarily store the power status data.

4. The electronic device according to claim 2, wherein the selecting unit switches to be electrically coupled to the data register, or switches to be electrically coupled to the power status register according to the switch signal.

5. The electronic device according to claim 2, wherein the signal control module further comprises:
a display data register, electrically coupled to the light emitting unit and the selecting unit, and configured to temporarily store an output of the selecting unit.

6. The electronic device according to claim 1, wherein the input switch comprises:
a first input unit, configured to produce the switch signal; and
a second input unit, configured to produce the address signal.

7. A display method, using a light emitting unit to display internal status of an electronic device, wherein the electronic device comprises the light emitting unit, a power control unit, a register data storage unit and an input switch, the method comprising:
producing a switch signal via the input switch;
selecting the register data storage unit or the power control unit according to the switch signal;
transmitting power status data of the power control unit to the light emitting unit, when selecting the power control unit; and
transmitting register data of the register data storage unit to the light emitting unit, when selecting the register data storage unit.

8. The display method according to claim 7, further comprising:
producing an address signal via the input switch;
transmitting the address signal to the register data storage unit, so that the register data storage unit provides the corresponding register data to a data register; and
transmitting the register data in the data register to the light emitting unit, when selecting the register data storage unit.

9. An electronic device, comprising:
an input switch configured to produce a switch signal and an address signal;
a power control unit configured to transmit power status data;
a register data storage unit configured to provide corresponding register data according to the address signal; and
a signal control module electrically coupled to the power control unit, the register data storage unit and the input switch, and configured to selectively receive the register data from the register data storage unit or the power status data from the power control unit according to the switch signal, and output the selected data.

10. The electronic device according to claim 9, further comprises a light emitting unit electrically coupled to the signal control module for receiving the selected data from the signal control module.

11. The electronic device according to claim 10, wherein the signal control module comprises:
a selecting unit electrically coupled to the input switch, and configured to receive the switch signal, and selectively transmit the power status data or the register data to the light emitting unit.

12. The electronic device according to claim 11, wherein the signal control module further comprises:
a data register electrically coupled to the register data storage unit and the selecting unit, and configured to temporarily store the register data; and
a power status register electrically coupled to the power control unit and the selecting unit, and configured to temporarily store the power status data.

13. The electronic device according to claim 11, wherein the selecting unit switches to be electrically coupled to the data register, or switches to be electrically coupled to the power status register according to the switch signal.

14. The electronic device according to claim 11, wherein the signal control module further comprises:
a display data register electrically coupled to the light emitting unit and the selecting unit, and configured to temporarily store an output of the selecting unit.

15. The electronic device according to claim 9, wherein the input switch comprises:
a first input unit configured to produce the switch signal; and
a second input unit configured to produce the address signal.
